(19) United States
(12) Patent Application Publication
(10) Pub. No.: US 2007/0210693 A1
(43) Pub. Date: Sep. 13, 2007

(54) DISPLAY

(76) Inventors: Masaaki KOMATSU, Kodaira (JP); Shin Imamura, Kokubunji (JP); Hirotaka Sakuma, Hachioji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/673,092

(22) Filed: Feb. 9, 2007

(30) Foreign Application Priority Data
Mar. 9, 2006 (JP) 2006-063491

(51) Int. Cl. H01J 1/62; H01J 63/04

(52) U.S. Cl. 313/487; 313/496

(57) ABSTRACT

To improve luminescence life, linearity of emission luminescence, and colority of an electron beam excitation display of thin flat type. The electron beam excitation display of thin flat type has a rear plate provided with a plurality of first electrodes in parallel with one another, a plurality of second electrodes in parallel with one another and orthogonal to the first electrodes, and electron emitters placed at points of intersection or near the points of intersection of the first electrodes and the second electrodes and a faceplate formed with a phosphor layer. By using a blue-emitting phosphor formed by mixing a blue-emitting phosphor ZnS:Ag and a blue-emitting phosphor CaMgSi₂O₆:Eu for the phosphor layer, the electron beam excitation display of thin flat type improved in luminescence life, linearity of emission luminescence, and colority that have been left unsolved is provided.

### CLAIM OF PRIORITY

The present application claims priority from Japanese application JP 2006-063491 filed on Mar. 9, 2006, the content of which is hereby incorporated by reference into this application.

### FIELD OF THE INVENTION

The present invention relates to a display provided with a faceplate formed with a phosphor layer and electron emitters that irradiate electron beams onto the phosphor layer, and more particularly to a display wherein a phosphor layer containing a blue-emitting phosphor CaMgSi₂O₆:Eu and a blue-emitting phosphor ZnS:Ag having approximately the same median diameter is used as a phosphor constituting the phosphor layer.

### BACKGROUND OF THE INVENTION

In video information systems, research and development of various displays are being actively carried out in response to a variety of demands such as for higher resolution, larger screen, lower-profiling, and lower power consumption. As a display that meets such demands and realizes lower-profiling and lower power consumption, research and development of an electron beam excitation display of thin flat type have been actively pursued in recent years. The electron beam excitation display of thin flat type has a structure in which electron emitters associated with each pixel (sub-pixel) are placed on the back surface of an enclosed vacuum box and a phosphor layer is arranged on the inner surface of a front faceplate, and video is displayed by irradiating electron beam of low accelerating voltage at an accelerating voltage of about 0.1 kV to 10 kV onto the phosphor layer to emit light. Here, the electron density of the electron beam irradiated onto the phosphor layer is a high electron density that is approximately 10-fold to 1,000-fold of a common cathode-ray tube, and therefore a low resistance characteristic that does not cause saturation with electric charge is desired for the phosphor layer for the electron beam excitation display of thin flat type. Further, a good characteristic of life under a high electron density, good color balance after long exposure to electron beam, and characteristics of less luminescence saturation and high luminescence are required.

There are several modes for the electron beam excitation display of thin flat type depending on an electron emitter used. A display in which a field-emission electron source such as Spindt type electron source or carbon nanotube type electron source is used as the electron emitter is called field emission display (FED). In addition to that, a display in which a surface conduction type electron source is used as the electron emitter and a display in which a thin type electron source that uses hot electron accelerated by an electron accelerator such as metal-insulator-metal (MIM) type electron source, ballistic electron surface-emitting display (BSD), or high efficiency electroemission device (HEED) is used as the electron emitter are known. Hereinafter, these electron beam excitation displays of thin flat type are collectively called “FED” (in a broad sense).

Various developments to realize a phosphor layer having a long life and high linearity (increase of emission luminescence relative to irradiated electron is high) have been carried out up to now. Although a blue-emitting phosphor ZnS:Ag is used in a high voltage type FED as described in Non-patent document 1 (J. Vac. Sci. Technol. A19(4) 2001, p 1083), there are problems such as contamination of emitter with sulfur, luminescence life of blue and green luminescent phosphors, and luminescence saturation (increase of emission luminescence relative to irradiated electron is slowed down). Further, although a blue-emitting phosphor Y₂SiO₅:Ce is used in a low voltage type FED as described in Non-patent document 2 (SID04, 19.4 L, p 832), there are problems that the luminescence is low and deterioration of colority in which the colority of blue luminescence is shifted in the direction of white color by long exposure to electron beam. On the other hand, a result of luminescence evaluation when a blue-emitting phosphor CaMgSi₂O₆:Eu as a novel blue-emitting oxide phosphor was excited by an electron beam of low accelerating voltage is described in Non-patent document 3 (Extended Abstract of the Fifth Int. Conf. of Display Phosphors 1999, p 317). However, there is no description of long life and high linearity characteristic of the blue-emitting phosphor CaMgSi₂O₆:Eu, nor is there any description of realizing a high performance FED by combining the blue-emitting phosphor CaMgSi₂O₆:Eu with a blue-emitting phosphor ZnS:Ag. Recently, a combination of a blue-emitting phosphor CaMgSi₂O₆:Eu and a blue-emitting phosphor ZnS:Ag is used as a blue-emitting phosphor layer for FED as disclosed in Patent document 1 (JP-A No. 197135/2003). However, the particle diameter of blue-emitting phosphor CaMgSi₂O₆:Eu is smaller than one half of blue-emitting phosphor ZnS:Ag, and the particle diameter of blue-emitting phosphor CaMgSi₂O₆:Eu falls short of exploiting the full performance of blue-emitting phosphor CaMgSi₂O₆:Eu.

In addition, a blue-emitting phosphor CaMgSi₂O₆:Eu is being used as a phosphor for vacuum-ultraviolet ray excitation as described in Patent document 2 (JP-A No. 332481/2002) and Non-patent document 4 (Asia Display/IDW '01. PHp1-7, p 1115), although not as a phosphor for FED. However, there is no description of realizing a high performance phosphor layer for electron beam excitation by combining the blue-emitting phosphor CaMgSi₂O₆:Eu with a blue-emitting phosphor ZnS:Ag.

Heretofore, various methods have been studied to realize a phosphor layer of low resistance, long life, and high luminescence for FED. However, all of the above problems have not yet been solved by these conventional methods. A new method to realize long life and high linearity is particularly needed.

### SUMMARY OF THE INVENTION

Hence, the objects of the present invention are to improve each characteristic of emission luminescence, luminescence life, linearity, and colority of the conventional phosphor layer described above and to provide a display having an excellent characteristic of luminescence life.

The above objects can be achieved by a display having a plurality of first electrodes in parallel with one another, a plurality of second electrodes in parallel with one another and orthogonal to the first electrodes, a rear plate with electron emitters placed at points of intersection or near the points of intersection of the first electrodes and the second electrodes, and a faceplate formed with a phosphor layer, where as the phosphor layer, a blue-emitting phosphor layer containing a blue-emitting phosphor CaMgSi₂O₆:Eu and a blue-emitting phosphor ZnS:Ag is used. In this case, the electron beam accelerating voltage of the display is mainly in the range of 1 kV or higher and 15 kV or lower. Further, it is desirable that the median particle diameters of the blue-emitting phosphor CaMgSi₂O₆:Eu and the blue-emitting phosphor ZnS:Ag have sizes sufficient to exercise performances of the phosphors as well as sizes suitable for screen-printing. In order to meet the demand for the median diameters of these phosphors, the median diameters of the blue-emitting phosphor CaMgSi₂O₆:Eu and the blue-emitting phosphor ZnS:Ag are made approximately equal to each other. Further, as for the range thereof in view of demand for emission luminescence, the median diameter of the blue-emitting phosphor CaMgSi₂O₆:Eu is preferably 50% or larger and further preferably 70% or larger of the median diameter of the blue-emitting phosphor ZnS:Ag. In view of demand for screen-printing, the median diameter of the blue-emitting phosphor CaMgSi₂O₆:Eu is preferably 200% or less of the median diameter of the blue-emitting phosphor ZnS:Ag. Such a median diameter of the blue-emitting phosphor CaMgSi₂O₆:Eu is approximately 3 μm or larger and 8 μm or smaller. In addition, when the mixing ratio of the blue-emitting phosphor CaMgSi₂O₆:Eu is 20% by weight or more of the blue-emitting phosphor ZnS:Ag, more satisfactory performances can be exerted.

Luminescence life of a blue phosphor layer is improved further by using a phosphor in which the cathode-luminescence spectrum of the blue-emitting phosphor ZnS:Ag shows a shoulder around 400 nm (3.10 eV) and its luminescence intensity is 2.5-fold or more of the intensity obtained by fitting a Gaussian carve. Such a blue-emitting phosphor ZnS:Ag can be produced by annealing at a processing temperature of 100 to 600 degrees C. in an atmosphere containing sulfur, and a decrease in sulfur vacancy concentration of the produced phosphor can be observed by measuring the thermoluminescence curve. Thus-produced blue-emitting phosphor ZnS:Ag is mixed with the blue-emitting phosphor CaMgSi₂O₆:Eu, thereby making it possible to realize a display with higher performances.

To the blue-emitting phosphor CaMgSi₂O₆:Eu, at least one kind of element selected from the group consisting of Group IIA, Group IIB, and Group IVB may be added. Emission luminescence and colority can be improved by adding these elements. In a method of phosphor synthesis using a flux in each phosphor, at least one kind of minute impurity selected from the group consisting of Group IA, Group VIIB, and rare earth may sometimes be contained. Further, to the blue-emitting phosphor ZnS:Ag, at least one kind of element selected from the group consisting of Group IIA, Group IIB, Group VIB, Group IB, and Group IIIB may be added. Emission luminescence can be improved by adding these elements. In a method of phosphor synthesis using a flux in each phosphor, at least one kind of minute impurity selected from the group consisting of Group IA, Group VIIB, and rare earth may sometimes be contained. In this way, it possible to realize a display with higher performances by mixing the blue-emitting phosphor CaMgSi₂O₆:Eu and the blue-emitting phosphor ZnS:Ag.

The display of the present invention makes use of a blue-emitting phosphor layer with a combination of the blue-emitting phosphor CaMgSi₂O₆:Eu and the blue-emitting phosphor ZnS:Ag, and therefore, linearity of emission luminescence is excellent, long life is achieved, and luminescence characteristic and colority balance are excellent even after driving for a long time.

### BRIEF DESCRIPTION OF THE DRAWINGS

FIG. 1 is a graph showing curves of luminescent maintenance factors of phosphor layers of the present invention;

FIG. 2 is a graph showing the curves of luminescent maintenance factors of phosphor layers of the present invention;

FIG. 3 is a schematic plan view of a display panel in Example 15 of the present invention;

FIG. 4 is a schematic cross sectional view of the display panel in Example 15 of the present invention;

FIG. 5A is a schematic cross sectional view of a portion of the display panel in Example 15 of the present invention;

FIG. 5B is a schematic cross sectional view in the orthogonal direction of the portion of the display panel in Example 15 of the present invention;

FIG. 6 is a schematic diagram showing an entire structure of a display with Spindt type electron source of the present invention; and

FIG. 7 is a schematic diagram showing an entire structure of a display with carbon nanotube type electron source.

### DETAILED DESCRIPTION OF THE PREFERRED EMBODIMENTS

Hereinafter, each characteristic of phosphors used in the display of the present invention with respect to luminescence, luminescent maintenance factor, and the like is described in detail. However, the following show examples which embody the present invention and in no way restrict the present invention.

### EXAMPLE 1

First, each characteristic of blue-emitting phosphors is explained. Characteristic of emission luminescence was evaluated using blue-emitting phosphors; Y₂SiO₅:Ce, ZnS:Ag,Cl, and CaMgSi₂O₆:Eu. A phosphor layer of each phosphor sample was formed on a Cu substrate plated with Ni by a sedimentation method. The weight of application was 2 to 5 mg/cm². The produced sample phosphor layer was set on a demountable apparatus mounted with an electron gun for measurement. An electron beam in the demountable apparatus was scanned from left to right and top to bottom at the same frequency as common television using deflection yoke to draw square raster (electron beam-irradiated area) in a certain area on the phosphor layer produced as described above. The emission luminescence and the luminescence through a radiometric filter (luminescence energy) were measured from the reflection side using a color-difference meter and a Si photocell. The evaluation of luminescence characteristics was carried out under the conditions of an accelerating voltage of 7 kV, irradiation area of 6×6 mm, irradiation current of 2 μA, electron density of 5.6 μA/cm², and sample temperature of 20 degrees C. The results of the evaluation of luminescence characteristics are shown in Table I. The emission luminescence of a phosphor CaMgSi₂O₆:Eu was 35.2% of that of a phosphor ZnS:Ag,Cl. The emission luminescence of a phosphor Y₂SiO₅:Ce was 65.2% of that of the phosphor ZnS:Ag,Cl. This is because the colority y value of the phosphor CaMgSi₂O₆:Eu is small and the colority y value of the phosphor Y₂SiO₅:Ce is large, which makes difference in luminescence in respect of luminosity. For comparison of luminescence characteristics of blue-emitting phosphors, it is appropriate to use luminescence energy. The luminescence energy of the phosphor CaMgSi₂O₆:Eu was as high as 52.8% compared to 28.2% of the phosphor Y₂SiO₅:Ce. The linearity of the phosphor CaMgSi₂O₆:Eu was as high as 0.97 compared to the phosphor ZnS:Ag,Cl (0.85), and therefore the luminescence energy of the phosphor CaMgSi₂O₆:Eu becomes closer to that of the phosphor ZnS:Ag,Cl as the current range becomes higher.

Next, luminescent maintenance factor of each blue-emitting phosphor was evaluated. The method for producing the sample and the apparatus for evaluating the luminescent maintenance factor were the same as those used in evaluating the characteristic of emission luminescence. An accelerated test for luminescent maintenance factor was carried out under the conditions of an accelerating voltage of 7 kV, irradiation area of 6×6 mm, irradiation current of 100 μA, electron density of 278 μA/cm², sample temperature of 200 degrees C., and electron beam irradiation time of 1 hour. The results of the evaluation of luminescent maintenance factor and colority change are shown in Table II. The luminescent maintenance factor of the phosphor ZnS:Ag,Cl (the luminescence energies before and after the accelerated test were compared under the conditions of an accelerating voltage of 7 kV, irradiation area of 6×6 mm, irradiation current of 2 μA, electron density of 5.6 μA/cm², and sample temperature of 20 degrees C.) was 80.4%, whereas the luminescent maintenance factors of the phosphor Y₂SiO₅:Ce and the phosphor CaMgSi₂O₆:Eu were as good as 92.9% and 95.8%, respectively. Although the luminescent maintenance factor of the phosphor Y₂SiO₅:Ce was higher than the phosphor ZnS:Ag,Cl, both of the colority x and the colority y increased after the accelerated test, and deterioration of colority in which luminescent color was shifted in the direction of white color was observed. Although the colority y of the phosphor CaMgSi₂O₆:Eu slightly increased after the accelerated test, its extent was approximately the same as the case of the phosphor ZnS:Ag,Cl.

TABLE I
Evaluation results of luminescence characteristics of
blue-emitting phosphors using demountable apparatus

| | Emission | | | | Luminescence | | |
|---|---|---|---|---|---|---|---|
| | luminescence | Relative | | | energy | Relative | |
| Composition | L(cd/m²) | value L | Colority x | Colority y | E (a.u.) | value E | Linearity γ |
| Y₂SiO₅:Ce | 15.0 | 65.2 | 0.184 | 0.196 | 42.6 | 28.2 | 0.98 |
| ZnS:Ag, Cl | 23.0 | 100.0 | 0.141 | 0.068 | 150.9 | 100.0 | 0.85 |
| CaMgSi₂O₆:Eu | 8.1 | 35.2 | 0.142 | 0.041 | 79.7 | 52.8 | 0.97 |

TABLE II
Evaluation results of luminescent maintenance
factors of blue-emitting phosphors using demountable apparatus

| | Luminescent | | | | | | |
|---|---|---|---|---|---|---|---|
| | maintenance | Before | After | | Before | After | |
| Composition | factor (%) | irradiation x | irradiation x | Δx | irradiation y | irradiation y | Δy |
| Y₂SiO₅:Ce | 92.9 | 0.183 | 0.192 | 0.009 | 0.196 | 0.214 | 0.018 |
| ZnS:Ag, Cl | 80.4 | 0.141 | 0.142 | 0.000 | 0.068 | 0.072 | 0.003 |
| CaMgSi₂O₆:Eu | 95.8 | 0.142 | 0.144 | 0.001 | 0.041 | 0.045 | 0.004 |

As described above, the emission luminescence of the phosphor ZnS:Ag,Cl was high, but its luminescence life was not sufficient. On the other hand, the phosphor CaMgSi₂O₆:Eu was good in linearity of emission luminescence, colority, and luminescence life but low in emission luminescence. As an oxide phosphor, however, the phosphor CaMgSi₂O₆:Eu is higher in luminescence energy compared to the phosphor Y₂SiO₅:Ce and is satisfactory in each performance as well. Accordingly, it is possible to realize a high-performance blue-emitting phosphor layer for FED having high luminescence, long life, and good colority and linearity by combining the phosphor ZnS:Ag,Cl having high luminescence and the phosphor CaMgSi₂O₆:Eu having long life. Further, it is possible to make the life of the phosphor layer longer by using the phosphor CaMgSi₂O₆:Eu having approximately the same median particle diameter as that of the phosphor ZnS:Ag,Cl and having higher emission luminescence. Specific examples of this are described below.

Characteristics of a fine particle phosphor CaMgSi₂O₆:Eu (median particle diameter, 2 μm) and the phosphor CaMgSi₂O₆:Eu used in the present invention (median particle diameter, 5 μm) were compared. The luminescence efficiency of each of the phosphor ZnS:Ag,Cl, the fine particle phosphor CaMgSi₂O₆:Eu (median particle diameter, 2 μm), and the phosphor CaMgSi₂O₆:Eu (median particle diameter, 5 μm) is shown in Table III. The measurement of the luminescence efficiency was carried out using a metal-insulator-metal (MIM) type electron source and an anode substrate applied with a phosphor with Al back formed thereon at an accelerating voltage of 7 kV. The luminescence efficiency of the phosphor ZnS:Ag,Cl was 3.3 lm/W. The luminescence efficiency of the fine particle phosphor CaMgSi₂O₆:Eu (median particle diameter, 2 μm) was 1.5 lm/W, whereas the luminescence efficiency of the phosphor CaMgSi₂O₆:Eu (median particle diameter, 5 μm) was as high as 1.8 lm/W. Accordingly, when the luminescence efficiency of a blue-emitting phosphor layer is set to 3.0 lm/W, the upper limit of the mixing ratio of the fine particle phosphor CaMgSi₂O₆:Eu (median particle diameter, 2 μm) to the phosphor ZnS:Ag,Cl is 16%. When the mixing ratio of the fine particle phosphor CaMgSi₂O₆:Eu (median particle diameter, 2 μm) is increased to more than 16%, the luminescence efficiency becomes lower than 3.0 lm/W because the luminescence efficiency of the fine particle phosphor CaMgSi₂O₆:Eu (median particle diameter, 2 μm) is low. On the other hand, the upper limit of the mixing ratio of the phosphor CaMgSi₂O₆:Eu (median particle diameter, 5 μm) to the phosphor ZnS:Ag,Cl is 20% because the luminescence efficiency of the phosphor CaMgSi₂O₆:Eu (median particle diameter, 5 μm) is higher than that of the fine particle phosphor CaMgSi₂O₆:Eu (median particle diameter, 2 μm). Since the luminescence life of the phosphor CaMgSi₂O₆:Eu is good as described above, the luminescence life becomes longer when the mixing ratio of the phosphor CaMgSi₂O₆:Eu is higher.

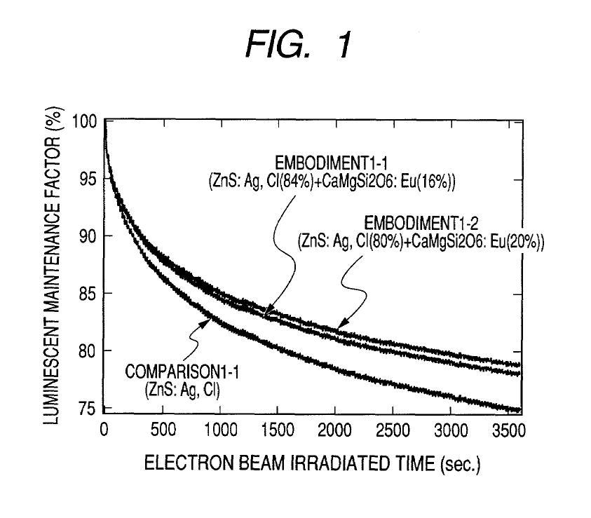

Examples of the present invention together with Comparative example are shown in Table IV. When the fine particle phosphor CaMgSi₂O₆:Eu (median particle diameter, 2 μm) was mixed with the phosphor ZnS:Ag,Cl, the luminescence life was improved by 56% relative to that of the phosphor ZnS:Ag,Cl (Example 1-1). Further, when the phosphor CaMgSi₂O₆:Eu (median particle diameter, 5 μm) was mixed with the phosphor ZnS:Ag,Cl, the luminescence life was improved by 84% relative to that of the phosphor ZnS:Ag,Cl (Example 1-2). A graph showing change in luminescent maintenance factor of each blue-emitting phosphor layer versus electron beam irradiation time is depicted in FIG. 1. The luminescence life of the blue-emitting phosphor layer of the present invention was improved compared to that of Comparative example.

TABLE III
Luminescence efficiency of blue-emitting phosphor
and limit of mixing with ZnS:Ag, Cl

| | Median | Luminescence | Limit of |
|---|---|---|---|
| | particle | efficiency | mixing with |
| Composition | diameter (μm) | (lm/W) | ZnS:Ag, Cl (%) |
| ZnS:Ag, Cl | 5 | 3.3 | — |
| CaMgSi₂O₆:Eu | 2 | 1.5 | 16 |
| CaMgSi₂O₆:Eu | 5 | 1.8 | 20 |

TABLE IV
Luminescence life of blue-emitting phosphor layer

| | ZnS:Ag, Cl | CaMgSi₂O₆:Eu | | |
|---|---|---|---|---|
| | median | median | | |
| | particle | particle | | |
| Composition | diameter | diameter | | Luminescence life |
| (mixed composition) | (μm) | (μm) | Example | (relative value) |
| ZnS:Ag, Cl | 5 | — | Comparative | 100 |
| | | | example 1 | |
| ZnS:Ag, Cl(84%) + | 5 | 2 | Example 1-1 | 156 |
| CaMgSi₂O₆:Eu(16%) | | | | |
| ZnS:Ag, Cl(80%) + | 5 | 5 | Example 1-2 | 184 |
| CaMgSi₂O₆:Eu(20%) | | | | |

The method to determine the mean particle diameter of a phosphor includes a determination method using a particle size distribution measuring instrument and a direct observation method using an electron microscope. For example, in the case of the determination using an electron microscope, when each class of variables of particle diameter of a phosphor ( . . . , 0.8 to 1.2 μm, 1.3 to 1.7 μm, 1.8 to 2.2 μm, . . . , 6.8 to 7.2 μm, 7.3 to 7.7 μm, 7.8 to 8.2 μm, . . . ) is expressed in class values ( . . . , 1.0 μm, 1.5 μm, 2.0 μm, . . . , 7.0 μm, 7.5 μm, 8.0 μm, . . . ) that are represented by xi and when the frequency of each variable observed with the electron microscope is denoted by fi, a median value M can be expressed as follows.

M=Σxifi/Σfi=Σxifi/N (Formula 1)

Note that Σfi is equal to N (Σfi=N). In this way, the median particle size of each phosphor can be determined.

### EXAMPLE 2

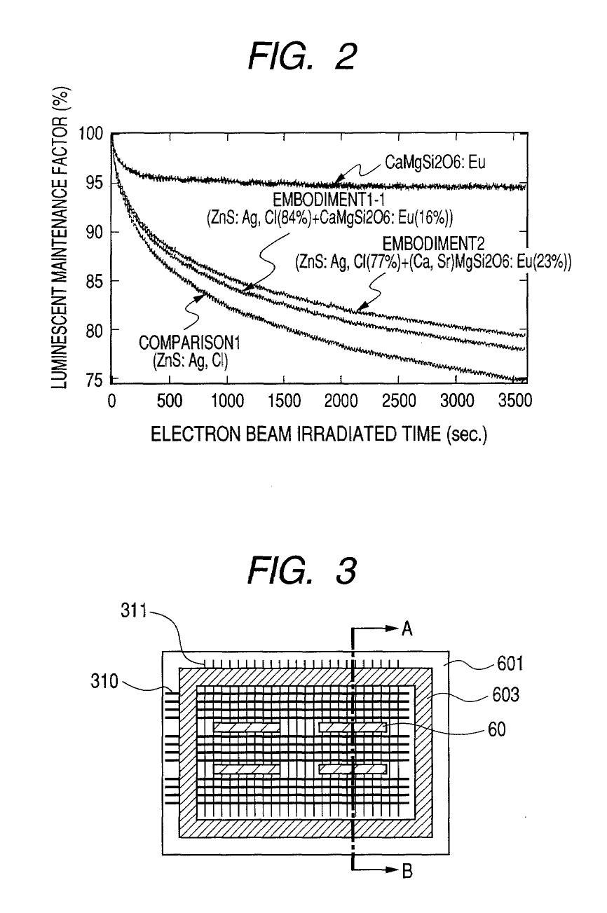

Next, an example in which a phosphor (Ca,Sr)MgSi₂O₆:Eu (median diameter, 4 μm) was mixed with the phosphor ZnS:Ag,Cl (median diameter, 5 μm) is described. The luminescence efficiency of each blue-emitting phosphor is shown in Table V. The luminescence efficiency of the phosphor (Ca,Sr)MgSi₂O₆:Eu (median diameter, 4 μm) was 2.0 lm/W and higher than the luminescence efficiency (1.5 lm/W) of the fine particle phosphor CaMgSi₂O₆:Eu (median diameter, 2 μm). Accordingly, when the luminescence efficiency of a blue-emitting phosphor layer is set to 3.0 lm/W, the upper limit of the mixing ratio of the fine particle phosphor CaMgSi₂O₆:Eu (median particle diameter, 2 μm) to the phosphor ZnS:Ag,Cl is 16%. When the mixing ratio of the fine particle phosphor CaMgSi₂O₆:Eu (median particle diameter, 2 μm) is increased to more than 16%, the luminescence efficiency becomes lower than 3.0 lm/W because the luminescence efficiency of the fine particle phosphor CaMgSi₂O₆:Eu (median particle diameter, 2 μm) is low. On the other hand, the upper limit of the mixing ratio of the phosphor (Ca,Sr)MgSi₂O₆:Eu (median diameter, 4 μm) to the phosphor ZnS:Ag,Cl is 23% because the luminescence efficiency of the phosphor (Ca,Sr)MgSi₂O₆:Eu is higher than that of the fine particle phosphor CaMgSi₂O₆:Eu (median diameter, 2 μm). Examples of the present invention together with Comparative example are shown in Table VI. When the (Ca,Sr) MgSi₂O₆:Eu (median particle diameter, 4 μm) was mixed with the phosphor ZnS:Ag,Cl, the luminescence life was improved by 102%, i.e. about 2-fold, relative to that of the phosphor ZnS:Ag,Cl (Example 2). A graph showing change of luminescent maintenance factor of each blue-emitting phosphor layer versus electron beam irradiation time is depicted in FIG. 2. The luminescence life of the blue-emitting phosphor layer of the present invention was improved compared to that of Comparative example.

TABLE V
Luminescence efficiency of blue-emitting phosphor and
limit of mixing with ZnS:Ag, Cl

| | Median | Luminescence | Limit of mixing |
|---|---|---|---|
| | particle | efficiency | with ZnS:Ag, Cl |
| composition | diameter (μm) | (lm/W) | (%) |
| ZnS:Ag, Cl | 5 | 3.3 | — |
| CaMgSi₂O₆:Eu | 2 | 1.5 | 16 |
| (Ca, Sr)MgSi₂O₆:Eu | 4 | 2.0 | 23 |

TABLE IV
Luminescence life of blue-emitting phosphor layer

| | ZnS:Ag, Cl | CaMgSi₂O₆:Eu | | |
|---|---|---|---|---|
| | median | median | | |
| | particle | particle | | |
| Composition (mixed | diameter | diameter | | Luminescence |
| composition) | (μm) | (μm) | Example | life |
| ZnS:Ag, Cl | 5 | — | Comparative | 100 |
| | | | example 1 | |
| ZnS:Ag, Cl(84%) + | 5 | 2 | Example 1-1 | 156 |
| CaMgSi₂O₆:Eu(16%) | | | | |
| ZnS:Ag, Cl(77%) + | 5 | 4 | Example 2 | 202 |
| (Ca, Sr)MgSi₂O₆:Eu(23%) | | | | |

### EXAMPLE 3

A blue-emitting phosphor CaMgSi₂O₆:Eu (median particle diameter, 8 μm) was mixed with a phosphor ZnS:Ag,Al (median particle diameter, 6 μm) to prepare a blue-emitting phosphor layer. The emission luminescence and luminescence life when irradiated with an electron beam were better compared to Example 1-2.

### EXAMPLE 4

The blue-emitting phosphor CaMgSi₂O₆:Eu (median particle diameter, 5 μm) was mixed with a phosphor ZnS:Ag,Al (median particle diameter, 5 μm) subjected to sulfidation at an annealing temperature of 400 degrees C. to prepare a blue-emitting phosphor layer. In the cathode-luminescence spectrum, an emission shoulder was observed at 400 nm (3.10 eV) on the shorter wavelength side of the blue emission peak at 450 nm, and its magnitude was 2.7-fold of the intensity obtained by fitting a Gaussian curve. Further, the thermoluminescence curve of the phosphor ZnS:Ag,Al showed no thermoluminescence peak around 450 K and was flat. The luminescence life when an electron beam was irradiated onto the phosphor layer prepared by mixing these phosphors was better compared to Example 1-2.

### EXAMPLE 5

A phosphor CaMgSi₂O₆:Eu (median particle diameter, 4 μm) and the phosphor Y₂SiO₅:Ce were mixed with a phosphor ZnS:Ag,Al (median particle diameter, 8 μm) to prepare a blue-emitting phosphor layer. The linearity and luminescence life when irradiated with an electron beam were good.

### EXAMPLE 6

A phosphor (Ba,Ca)MgSi₂O₆:Eu (median particle diameter, 4 μm) was mixed with a phosphor ZnSrS:Ag,Al (median particle diameter, 6 μm) to prepare a blue-emitting phosphor layer. The luminescence life when irradiated with an electron beam was good.

### EXAMPLE 7

A phosphor CaMg(Si,Ge)₂O₆:Eu (median diameter, 5 μm) was mixed with a phosphor ZnS:Ag,Cu,Al (median particle diameter, 4 μm) to prepare a blue-emitting phosphor layer. The luminescence life when irradiated with an electron beam was good.

### EXAMPLE 8

A phosphor (Ba,Sr,Ca)MgSi₂O₆:Eu (median diameter, 6 μm) was mixed with a phosphor ZnS:Ag,Al,Ga (median particle diameter, 3 μm) to prepare a blue-emitting phosphor layer. The emission luminescence and colority when irradiated with an electron beam were good.

### EXAMPLE 9

A phosphor CaMgSi₂O₆:Eu (median diameter, 6 μm) containing F as a minute impurity was mixed with a phosphor ZnS:Ag,Al (median particle diameter, 5 μm) containing Na, K, and Cl as minute impurities to prepare a blue-emitting phosphor layer. The colority, linearity, and luminescence life when irradiated with an electron beam were almost as good as those in Example 3.

### EXAMPLE 10

A phosphor CaMgSi₂O₆:Eu,Tb (median particle diameter, 3 μm) was mixed with the phosphor ZnS:Ag,Al (median particle diameter, 5 μm) to prepare a blue-emitting phosphor layer. The luminescence life when irradiated with an electron beam was good.

### EXAMPLE 11

A phosphor (Ca,Sc)MgSi₂O₆:Eu,Ce (median particle diameter, 6 μm) was mixed with the phosphor ZnS:Ag,Al (median particle diameter, 6 μm) to prepare a blue-emitting phosphor layer. The luminescence life when irradiated with an electron beam was good.

### EXAMPLE 12

A phosphor (Ca,Gd)MgSi₂O₆:Eu,Tm (median particle diameter, 4 μm) was mixed with a phosphor ZnS:Ag,Al (median particle diameter, 4 μm) to prepare a blue-emitting phosphor layer. The luminescence life when irradiated with an electron beam was good.

### EXAMPLE 13

A phosphor (Ca,Y)MgSi₂O₆:Eu (median particle diameter, 5 μm) was mixed with the phosphor ZnS:Ag,Al (median particle diameter, 5 μm) to prepare a blue-emitting phosphor layer. The luminescence life when irradiated with an electron beam was good.

### EXAMPLE 14

A phosphor (Ca,Lu)MgSi₂O₆:Eu (median particle diameter, 3 μm) was mixed with a phosphor ZnS:Ag,Al (median particle diameter, 3 μm) to prepare a blue-emitting phosphor layer. The luminescence life when irradiated with an electron beam was good.

### EXAMPLE 15

Display with MIM Type Electron Source—Part 1

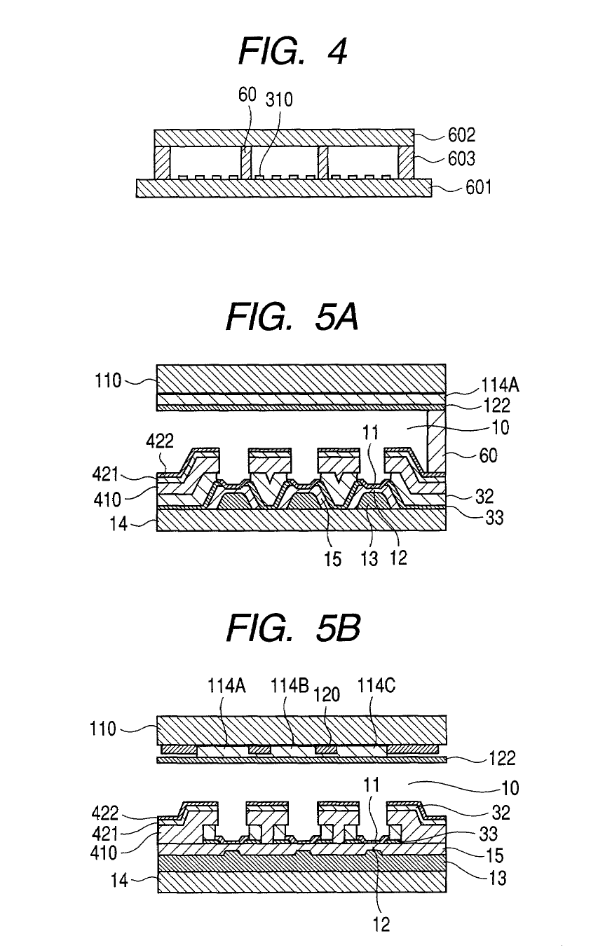

In this example, a thin type electron source was used for electron emitters 301. More specifically, an MIM type electron source was used. FIG. 3 is a plan view of a display panel used in the present example. FIG. 4 is a cross sectional view taken along A-B of FIG. 3. The interior enclosed by a cathode substrate 601, an anode substrate 602, and a frame 603 is in vacuum. To withstand atmospheric pressure, spacers 60 are placed in the vacuum region. The shape, number, and location of the spacer are arbitrary. On the cathode substrate 601, scanning electrodes 310 are arranged in the horizontal direction, and data electrodes 311 are arranged orthogonally to the scanning electrodes. The points of intersection of the scanning electrodes 310 and the data electrodes 311 correspond to sub-pixels. Here, sub-pixels independently correspond to red, green, and blue sub-pixels respectively in a color display. Although only 12 scanning electrodes 310 are depicted in FIG. 3, there are several hundreds to several thousands scanning electrodes in a practical display. The same is true for the data electrodes 311. At the points of intersection of the scanning electrodes 310 and the data electrodes 311, the electron emitters 301 are placed. In the present example, a thin type electron source is used as the electron emitter 301. Electron emitting regions are located in areas where the scanning electrodes 310 and upper part electrode bus lines 32 intersect each other, and electrons are emitted from these regions. FIG. 5 shows a cross sectional view of the display panel used in the present example. FIG. 5A is a cross sectional view taken along the line A-B of FIG. 3 (only three sub-pixel portions are depicted), and FIG. 5B is a cross sectional view in the direction orthogonal thereto (only three sub-pixel portions are depicted).

The structure of the cathode substrate 601 is as follows. On an insulative rear plate 14 formed of such as glass, the thin type electron source 301 constructed from lower part electrodes 13 (Al), an insulator layers 12 (Al₂O₃), and upper part electrodes 11 (Ir—Pt—Au) is formed. The upper part electrode bus lines 32 are electrically connected to the upper part electrodes 11 via an upper part electrode bus line underlayer 33 and serve as electric supply lines to the upper part electrodes 11. Further, the upper part electrode bus lines 32 serve as the data electrodes 311 in the present example. The regions where the electron emitters 301 are arranged in matrix form on the cathode substrate 601 (referred to as cathode arrangement region 610) are covered with an interlayer insulator layer 410, and a common electrode 420 is formed thereon. The common electrode 420 is formed of a laminate layer of a common electrode layer A421 and a common electrode layer B422. The common electrode is connected to earth potential. The spacer 60 is in contact with the common electrode 420 and serves functions to allow electric current to flow from an acceleration electrode 122 of the anode substrate 602 through the spacer 60 and to allow electric charge to flow from the spacer 60. It should be noted that in FIG. 5, the reduced scale in the height direction is arbitrary. That is, the thicknesses of the lower part electrode 13, the upper part electrode bus line 32, and the like are several micrometers or less, whereas the distance between the rear plate 14 and a faceplate 110 is approximately 1 to 3 mm long. The production method of the cathode substrate 601 is disclosed in JP-A No. 323148/2003.

A phosphor layer consisting of 114A, 114B, and 114C formed of a blue-emitting phosphor comprising a mixture of a blue-emitting phosphor ZnS:Ag and a blue-emitting phosphor CaMgSi₂O₆:Eu, a green-emitting phosphor ZnS:Cu,Al and a red-emitting phosphor Y₂O₃:Eu, respectively, was present on the inside of the anode substrate 602. To enhance the resolution, a black conductive layer was provided per pixel. For the production of the black conductive layer, a photoresist layer was coated on the entire surface, exposed to light through a mask and developed while partially leaving the photoresist layer. Subsequently, a graphite layer was formed over the entire surface, and then the photoresist layer and graphite thereon were removed by treatment with hydrogen peroxide and the like to form the black conductive layer. For application of the phosphor layer, a screen-printing method was used. A phosphor was kneaded with a vehicle mainly composed of a cellulose resin and the like to prepare a paste. Next, the paste was screen-printed through a stainless mesh. Coating with red, green, and blue phosphors was carried out separately by adjusting the position of the mesh hole to that of each phosphor layer. Then, the phosphor layer formed by printing was baked to remove the mixed cellulose resin and the like. A phosphor pattern was formed in this manner. The acceleration electrode 122 (metal back) was prepared by vacuum deposition of Al after the inner surface of the phosphor layer had been subjected to a filming process. After that, the filming agent was removed by heat treatment to produce the acceleration electrode 122. In this way, the anode substrate 602 was completed.

An appropriate number of the spacers 60 were arranged between the cathode substrate 601 and the anode substrate 602. As shown in FIGS. 3 and 4, the cathode substrate 601 and the anode substrate 602 were attached by sealing by interposing the frame 603. Further, a space 10 enclosed by the cathode substrate 601, the anode substrate 602, and the frame 603 was exhausted to vacuum. A display panel 100 was completed as described above.

### EXAMPLE 16

Display with MIM Type Electron Source—Part 2

The display with MIM type electron source of the present invention is shown in FIG. 5. Particularly, the phosphor layer consisting of 114A, 114B, and 114C formed of a blue-emitting phosphor comprising a mixture of a blue-emitting phosphor ZnS:Ag and a blue-emitting phosphor CaMgSi₂O₆:Eu, a green-emitting phosphor Y₂SiO₅:Tb, and a red-emitting phosphor Y₂O₂S:Eu, respectively, was present on the inside of the anode substrate 602. The methods for forming the phosphor layer, the black conductive layer, and the metal back were the same as those in Example 15. The combination of these phosphors was particularly good for the luminescence life.

### EXAMPLE 17

Display with MIM Type Electron Source—Part 3

The display with MIM type electron source of the present invention is shown in FIG. 5. Particularly, the phosphor layer consisting of 114A, 114B, and 114C formed of a blue-emitting phosphor comprising a mixture of a blue-emitting phosphor ZnS:Ag and a blue-emitting phosphor CaMgSi₂O₆:Eu, a green-emitting phosphor Y₂SiO₅:Tb, and a red-emitting phosphor comprising a mixture of red-emitting phosphors Y₂O₂S:Eu and Y₂O₃:Eu, respectively, was present on the inside of the anode substrate 602. The methods for forming the phosphor layer, the black conductive layer, and the metal back were the same as those in Example 15. The combination of these phosphors was particularly good for the linearity and luminescence life.

### EXAMPLE 18

Display with MIM Type Electron Source—Part 4

The display with MIM type electron source of the present invention is shown in FIG. 5. Particularly, the phosphor layer consisting of 114A, 114B, and 114C formed of a blue-emitting phosphor comprising a mixture of a blue-emitting phosphor ZnS:Ag,Al and a blue-emitting phosphor (Ca,Sr)MgSi₂O₆:Eu, a green-emitting phosphor (Y,Sc)₂SiO₅:Tb, and a red-emitting phosphor Y₂O₃:Eu, respectively, was present on the inside of the anode substrate 602. The methods for forming the phosphor layer, the black conductive layer, and the metal back were the same as those in Example 15. The emission luminescence was improved by the combination of these phosphors compared to that in Example 17.

### EXAMPLE 19

Display with MIM Type Electron Source—Part 5

The display with MIM type electron source of the present invention is shown in FIG. 5. Particularly, the phosphor layer consisting of 114A, 114B, and 114C formed of a blue-emitting phosphor comprising a mixture of a blue-emitting phosphor ZnS:Ag,Cl and a blue-emitting phosphor CaMg(Si,Ge)₂O₆:Eu, a green-emitting phosphor (Y,Gd)₂SiO₅:Tb, and a red-emitting phosphor Y₂O₃:Eu, respectively, was present on the inside of the anode substrate 602. The methods for forming the phosphor layer, the black conductive layer, and the metal back were the same as those in Example 15.

### EXAMPLE 20

Display with MIM Type Electron Source—Part 6

The display with MIM type electron source of the present invention is shown in FIG. 5. Particularly, the phosphor layer consisting of 114A, 114B, and 114C formed of a blue-emitting phosphor comprising a mixture of a blue-emitting phosphor ZnS:Ag,Al and a blue-emitting phosphor Ca(Mg,Zn)Si₂O₆:Eu, a green-emitting phosphor (Y,Dy)₂SiO₅:Tb, and a red-emitting phosphor Y₂O₃:Eu, respectively, was present on the inside of the anode substrate 602. The methods for forming the phosphor layer, the black conductive layer, and the metal back were the same as those in Example 15.

### EXAMPLE 21

Display with Spindt Type Electron Source—Part 1

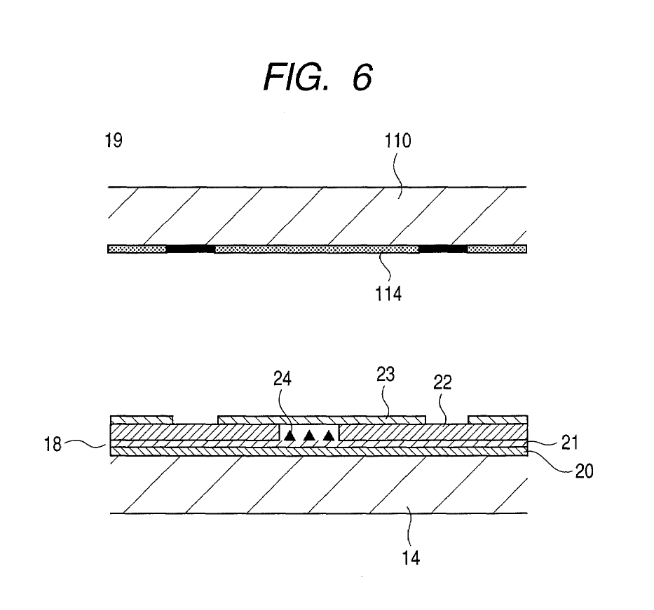

A display with Spindt type electron source of the present invention is shown in FIG. 6. The display with Spindt type electron source 19 is constructed from the faceplate 110, a Spindt type electron source 18, and the rear plate 14, and the Spindt type electron source 18 is formed by a cathode 20, a resistance layer 21, an insulator layer 22, gates 23, and Spindt type electron emitters (Mo etc.) 24. Particularly, a phosphor layer 114 formed of a blue-emitting phosphor comprising a mixture of a blue-emitting phosphor ZnS:Ag,Al and a blue-emitting phosphor CaMgSi₂O₆:Eu, a green-emitting phosphor Y₂SiO₅:Tb, and a red-emitting phosphor Y₂O₃:Eu was present on the inside of the faceplate 110. The methods for forming the phosphor layer, the black conductive layer, and the metal back were the same as those in Example 15. The emission luminescence, linearity, luminescence life, and colority were as good as those in Example 15.

A field-emission type electron source such as Spindt type electron source has a characteristic that the electron emission performance is markedly deteriorated when sulfur atom (S) deposits on the surface thereof. Therefore, it is possible to make the life of electron emitter longer as well as the stability thereof improved by the use of a combination of phosphors reduced in sulfur content as in the present example.

### EXAMPLE 22

Display with Spindt Type Electron Source—Part 2

The display with Spindt type electron source of the present invention is shown in FIG. 6. Particularly, the phosphor layer 114 formed of a blue-emitting phosphor comprising a mixture of a blue-emitting phosphor ZnS:Ag,Al,Cl and a blue-emitting phosphor CaMgSi₂O₆:Eu, a green-emitting phosphor Y₂SiO₅:Tb, and a red-emitting phosphor Y₂O₂S:Eu was present on the inside of the faceplate 110. The methods for forming the phosphor layer, the black conductive layer, and the metal back were the same as those in Example 15.

### EXAMPLE 23

Display with Spindt Type Electron Source—Part 3

The display with Spindt type electron source of the present invention is shown in FIG. 6. Particularly, the phosphor layer 114 formed of a blue-emitting phosphor comprising a mixture of a blue-emitting phosphor ZnS:Ag,Cl and a blue-emitting phosphor CaMgSi₂O₆:Eu, a green-emitting phosphor Y₂SiO₅:Tb, and a red-emitting phosphor comprising a mixture of red phosphors Y₂O₂S:Eu and Y₂O₃:Eu was present on the inside of the faceplate 110. Further, a conductive material In₂O₃ was mixed into the phosphor layer in order to reduce the phosphor resistance. The methods for forming the phosphor layer, the black conductive layer, and the metal back were the same as those in Example 15.

### EXAMPLE 24

Display with Carbon Nanotube Type Electron Source—Part 1

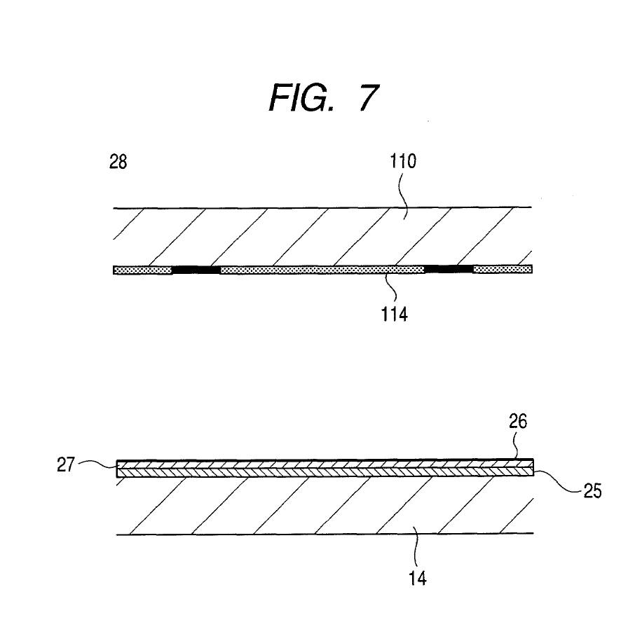

A display with carbon nanotube type electron source of the present invention is shown in FIG. 7. The display with carbon nanotube type electron source 28 is constructed from the faceplate 110, a carbon nanotube type electron source 27, and the rear plate 14, and the carbon nanotube type electron source 27 is formed by an electrode 25 and a carbon nanotube layer 26. Particularly, the phosphor layer 114 formed of a blue-emitting phosphor comprising a mixture of a blue-emitting phosphor ZnS:Ag,Al and a blue-emitting phosphor CaMgSi₂O₆:Eu, a green-emitting phosphor Y₂SiO₅:Tb, and a red-emitting phosphor Y₂O₃:Eu was present on the inside of the faceplate 110. The methods for forming the phosphor layer, the black conductive layer, and the metal back were the same as those in Example 15.

A field-emission type electron source such as carbon nanotube type electron source has a characteristic that the electron emission performance is markedly deteriorated when sulfur atom (S) deposits on the surface thereof. Therefore, it is possible to make the life of electron emitter longer as well as the stability thereof improved by the use of a combination of phosphors reduced in sulfur content as in the present example.

### EXAMPLE 25

Display with Carbon Nanotube Type Electron Source—Part 2

The display with carbon nanotube type electron source of the present invention is shown in FIG. 7. Particularly, the phosphor layer 114 formed of a blue-emitting phosphor comprising a mixture of a blue-emitting phosphor ZnS:Ag,Cl and a blue-emitting phosphor CaMgSi₂O₆:Eu, a green-emitting phosphor Y₂SiO₅:Tb, and a red-emitting phosphor Y₂O₂S:Eu was present on the inside of the faceplate 110. The methods for forming the phosphor layer, the black conductive layer, and the metal back were the same as those in Example 15.

### EXAMPLE 26

Display with Carbon Nanotube Type Electron Source—Part 3

The display with carbon nanotube type electron source of the present invention is shown in FIG. 7. Particularly, the phosphor layer 114 formed of a blue-emitting phosphor comprising a mixture of a blue-emitting phosphor ZnS:Ag,Al,Cl and a blue-emitting phosphor CaMgSi₂O₆:Eu, a green-emitting phosphor Y₂SiO₅:Tb, and a red-emitting phosphor comprising a mixture of Y₂O₂S:Eu and Y₂O₃:Eu was present on the inside of the faceplate 110. Further, the conductive material In₂O₃ was mixed into the phosphor layer in order to reduce the phosphor resistance. The methods for forming the phosphor layer, the black conductive layer, and the metal back were the same as those in Example 15.

What is claimed is:

1. A display comprising:
a rear plate having a plurality of first electrodes in parallel with one another, a plurality of second electrodes in parallel with one another and orthogonal to the first electrodes, and electron emitters placed at points of intersection or near the points of intersection of the first electrodes and the second electrodes; and
a faceplate formed with a phosphor layer and opposite to the rear plate, wherein as the phosphor layer, a blue-emitting phosphor layer containing a blue-emitting phosphor CaMgSi₂O₆:Eu and a blue-emitting phosphor ZnS:Ag is used.

2. The display according to claim 1, wherein the median diameter of the blue-emitting phosphor CaMgSi₂O₆:Eu and the median diameter of the blue-emitting phosphor ZnS:Ag are approximately the same.

3. The display according to claim 1, wherein the median diameter of the blue-emitting phosphor CaMgSi₂O₆:Eu is 70% or more of the median diameter of the blue-emitting phosphor ZnS:Ag.

4. The display according to claim 1, wherein the median diameter of the blue-emitting phosphor CaMgSi₂O₆:Eu is 3 μm or larger and 8 μm or smaller.

5. The display according to claim 1, wherein the mixing ratio of the blue-emitting phosphor CaMgSi₂O₆:Eu is 20% by weight or more of the blue-emitting phosphor ZnS:Ag.

6. The display according to claim 1, wherein a blue-emitting phosphor layer in which at least one kind of element selected from the group consisting of Group IIA, Group IIB, and Group IVB is added to the blue-emitting phosphor CaMgSi₂O₆:Eu is used.

7. The display according to claim 1, wherein a blue-emitting phosphor layer in which at least one kind of element selected from the group consisting of Group IIA, Group IIB, Group VIB, Group IB, and Group IIIB is added to the blue-emitting phosphor ZnS:Ag is used.

8. The display according to claim 1, wherein a phosphor forming the phosphor layer contains at least one kind of minute impurity selected from the group consisting of Group IA, Group VIIB, and rare earth.

9. The display according to claim 1, wherein the luminescence spectrum of the blue-emitting phosphor ZnS:Ag shows a shoulder around 400 nm (3.10 eV).

10. The display according to claim 1, wherein the luminescence intensity at 400 nm (3.10 eV) in the luminescence spectrum of the blue-emitting phosphor ZnS:Ag is 2.5-fold or more of the intensity obtained by fitting a Gaussian curve.

11. A method for producing a display according to claim 1, comprising:
producing a blue-emitting phosphor ZnS:Ag by annealing at a processing temperature of 100 to 600 degrees C. in an atmosphere containing sulfur to decrease the sulfur vacancy concentration thereof; and
mixing the blue-emitting phosphor ZnS:Ag with a blue-emitting phosphor CaMgSi₂O₆:Eu.

12. The display according to claim 1, wherein the median diameter of the blue-emitting phosphor CaMgSi₂O₆:Eu is 50% or more of the median diameter of the blue-emitting phosphor ZnS:Ag.

13. The display according to claim 1, wherein the median diameter of the blue-emitting phosphor CaMgSi₂O₆:Eu is 200% or less of the median diameter of the blue-emitting phosphor ZnS:Ag.

14. The display according to claim 1, wherein the accelerating voltage of electron beam emitted from the electron emitter to the phosphor layer is 1 kV or higher and 15 kV or lower.
